(19) United States
(12) Patent Application Publication
(10) Pub. No.: US 2020/0109583 A1
(43) Pub. Date: Apr. 9, 2020

(54) CAMS WITH NON-RADIAL ABRASION EDGES

(71) Applicant: HEWLETT-PACKARD DEVELOPMENT COMPANY, L.P., SPRING, TX (US)

(72) Inventors: WEI-CHUNG CHEN, TAIPEI CITY (TW); KUAN-TING WU, TAIPEI CITY (TW); CHUNG-HUA KU, TAIPEI CITY (TW)

(21) Appl. No.: 16/605,946

(22) PCT Filed: Jun. 26, 2017
(86) PCT No.: PCT/US2017/039216

§ 371 Date: Oct. 17, 2019

(51) Int. Cl. E05D 11/10; G06F 1/16

(52) U.S. Cl. CPC E05D 11/1042; G06F 1/1616; G06F 1/1679; G06F 1/1681

(57) ABSTRACT

Example implementations relate to cams with non-radial abrasion edges. In some examples, a cam can comprise a first annular surface having an outer radius and an inner radius, a second annular surface having the outer radius and the inner radius, a contact surface connecting the first annular surface to the second annular surface, and a non-radial abrasion edge with respect to the outer radius and the inner radius. The non-radial abrasion edge can be at a distal end of the contact surface.

### BACKGROUND

Cams can be used in electronic devices. For example, cams can be used in hinges coupling a kickstand to a display of an electronic device. Examples of electronic devices include laptops, tablets, and mobile phones, among other types of electronic devices.

### BRIEF DESCRIPTION OF THE DRAWINGS

FIG. 1 illustrates an example of a cam with non-radial abrasion edges consistent with the disclosure.

FIG. 2 illustrates a portion of an example of a cam with a non-radial abrasion edge consistent with the disclosure.

FIG. 3 illustrates an example of a cam with non-radial abrasion edges consistent with the disclosure.

FIG. 4 illustrates a graph of a torque profile of an example of cams with non-radial abrasion edges consistent with the disclosure.

FIG. 5 illustrates an example of a hinge including an example of cams with non-radial abrasion edges consistent with the disclosure.

FIG. 6 illustrates an example electronic device including of an example of a hinge including an example of cams with non-radial abrasion edges consistent with the disclosure.

### DETAILED DESCRIPTION

Cams can be used in hinges of electronic devices. In some examples, cams can be used in hinges coupling a kickstand to a display of an electronic device or hinges coupling a display to a base of an electronic device. Cams may include contact surfaces to control an amount of rotation of a hinge. For example, a contact surface may control the amount of rotation of a hinge included in a kickstand and thereby control how much the kickstand may be opened from a first orientation (e.g., a closed orientation) to a second orientation (e.g., an open position). At a distal end of a contact surface there may be an abrasion edge.

In some approaches, abrasion edges may be radial abrasion edges. As used herein, “radial abrasion edges” refer to abrasion edges that coincide with a radius of the cam. That is, the length of radial abrasion edges may be limited to the difference of an outer radius of a cam and the inner radius of the cam.

However, a radial abrasion edge may become damaged during the course of operation of the cam, for instance, during operation (rotation) of a hinge including the cam. As a result of such damage, the cam and therefore the hinge may permit a greater degree of rotation (e.g., 62 degrees of possible rotation) than an amount of rotation (e.g., 60 degrees of possible rotation) the cam or the hinge was designed to permit. Stated differently, the cam or hinge may experience an “angle shift.” That is, as used herein, “angle shift” refers to a difference between an actual degree of rotation permitted by a cam and a designed degree of rotation of the cam (i.e., an amount of rotation permitted by an undamaged cam). For example, an angle shift of two degrees the amount of rotation of a cam, or a hinge including a cam, may allow a kickstand to rotate such that an angle between the display and a surface in contact with the kickstand may decrease. The decrease in the angle may make it difficult for a user to see the display clearly without straining the user's neck. Thus, the display may not be in an ergonomic position relative to a user because of the hinge rotating more than amount of rotation of a kickstand has increased.

To avoid the issues associated with damage to abrasion edges, it can be beneficial to increase the length of abrasion edges, Increasing the length of an abrasion edge can reduce the risk of deterioration of and/or damage to the abrasion edge. Increasing the length of the abrasion edge allows the force associated with rotating the cam, or a hinge including the cam, to be distributed along the longer abrasion edge thereby reducing the amount of pressure and/or stress applied to the abrasion edge. Increasing the length of an abrasion edge can increase the quantity of cycles of a cam, or a hinge including a cam, before the abrasion edges begin to deteriorate and/or become damaged. As used herein, a “cycle” refers to rotating a cam, or a hinge including a cam, from a first orientation to a second orientation, or vice versa. For example, a cycle can be rotating a kickstand including a hinge including a cam from a closed orientation to an open orientation or from an open orientation to a closed orientation. The length of a radial abrasion edge can be increased by increasing a dimension of the cam. For example, the outer radius may be increased or the inner radius may be decreased.

In contrast, cams with non-radial abrasion edges can have longer abrasion edges relative to some approaches without having to increase a dimension of the cam. As used herein, “non-radial abrasion edges” refer to abrasion edges that do not coincide with a radius of the cam. Thus, the length of non-radial abrasion edges is not limited to the difference of an outer radius of a cam and the inner radius of the cam and can be greater than the difference. Non-radial abrasion edges can be longer than abrasion edges of some approaches, thereby reducing the risk of deterioration of and/or damage to the non-radial abrasion edge and/or increasing the quantity of cycles of a cam, or a hinge including a cam, before the non-radial abrasion edges begin to deteriorate and/or become damaged. For example, whereas in some approaches radial abrasion edges may deteriorate and/or become damaged after 25,000 cycles, cams with non-radial abrasion edges, as described herein, can desirably surpass 25,000 cycles before any deterioration of or damage to the non-radial abrasion edges occurs.

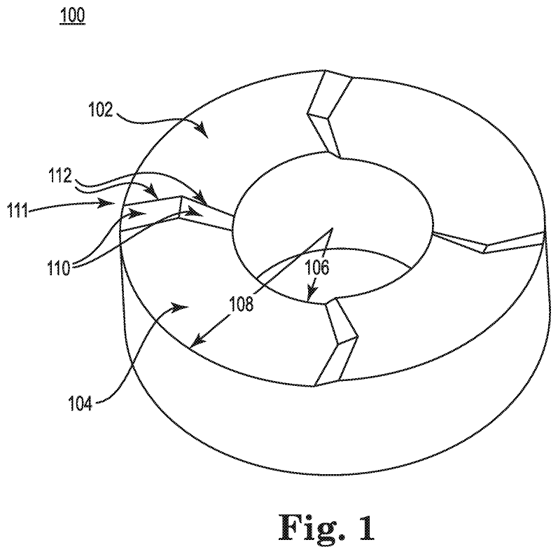

FIG. 1 illustrates an example of cams with non-radial abrasion edges consistent with the disclosure. As shown in FIG. 1, the cam 100 can be annular in shape. The cam 100 can include a first annular surface 102 and a second annular surface 104. The contact surface 110 can connect the first annular surface 102 to the second annular surface 104. At a distal end 111 of the contact surface 110 is a non-radial abrasion edge 112. In the example of FIG. 1, the non-radial abrasion edge 112 is a chevron (V-shaped) non-radial abrasion edge.

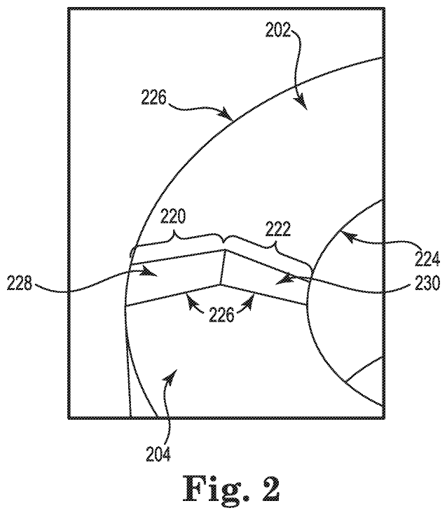

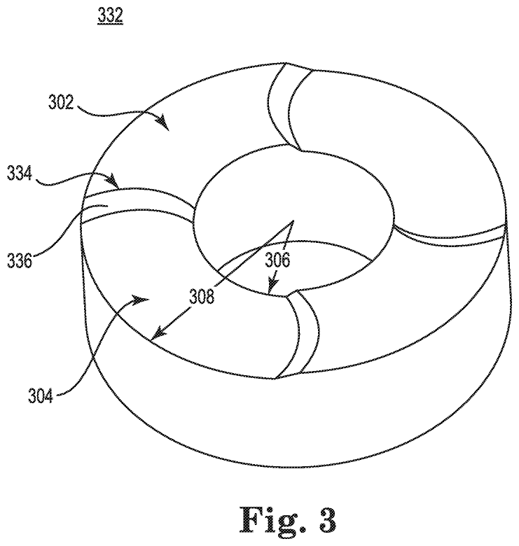

The non-radial abrasion edge 112 includes the two non-radial portions forming the chevron shape. Similarly, the contact surface 110 includes the two non-radial surfaces forming the chevron shape. As shown in FIG. 1, the non-radial abrasion edge 112 does not coincide with the inner radius 106 of the cam 100 or the outer radius 108 of the cam 100. Thus, the length of the non-radial abrasion edge 112 is greater than the difference between the outer radius 108 and the inner radius 106. The chevron shape of the non-radial abrasion edge 112 is discussed further in association with FIG. 2 below. Although FIG. 1 illustrates the non-radial abrasion edge 112 as a chevron non-radial abrasion edge, examples of cams with non-radial abrasion edges are not so limited. For example, non-radial abrasion edges can be curved as illustrated in FIG. 3.

The contact surface 110 can be analogized to an angled projection of the non-radial abrasion edge 112 from the first annular surface 102 to the second annular surface 104. The angle between the contact surface 110 and the second annular surface 104 can be adjusted to adjust the area of the contact surface 110. Increasing the angle between the contact surface 110 and the second annular surface 104 can increase the area of the contact surface 110 whereas decreasing the angle can decrease the area of the contact surface 110.

As shown in FIG. 1, some examples can include multiple instances of the non-radial abrasion edge 112 and the contact surface 110. A first contact surface and a second contact surface can be oppositely oriented. In some examples, an angle of a first chevron contact surface, such as the contact surface 110, can face the angle of a second chevron contact surface. Although not illustrated in FIG. 1, the cam 100 can be a double sided cam. The cam 100 can include a third annular surface opposite to the first annular surface 102 and a fourth annular surface opposite to the second annular surface 104. The third annular surface and the fourth annular surface can be separated from the first annular surface 102 and the second annular surface 104, respectively, by the thickness of the cam 100.

FIG. 2 illustrates a portion of an example of a cam with a non-radial abrasion edge consistent with the disclosure. The portion of the cam illustrated in FIG. 2 can be analogous to the cam 100 illustrated in FIG. 1. The first annular surface 202 and the second annular surface 204 can be analogous to the first annular surface 102 and the second annular surface 104, respectively.

FIG. 2 illustrates a chevron non-radial abrasion edge. The chevron non-radial abrasion edge includes a first non-radial portion 220 and a second non-radial portion 222. The first non-radial portion 220 and the second non-radial portion 222 together can be analogous to the non-radial abrasion edge 112 illustrated in FIG. 1. Neither the first non-radial portion 220 nor the second non-radial portion 222 coincides with a radius of the cam. The first non-radial portion 220 can have a first distal end at the outer circumference 226 of the cam and a second distal end at a first distal end of the second non-radial portion 222. The second non-radial portion 222 can have a second distal end at the inner circumference 224 of the cam. The first non-radial portion 220 can have a first length and the second non-radial portion 222 can have a second length. The sum of the first length and the second length can be greater than the difference between the outer and inner radii of the cam. The second length can be substantially equal to the first length.

FIG. 2 illustrates a chevron contact surface. The chevron contact surface can include a first non-radial surface 228 and a second non-radial surface 230, The first non-radial surface 228 and the second non-radial surface 230 together can connect the first annular surface 202 to the second annular surface 204. The first non-radial surface 228 and the second non-radial surface 230 together can be analogous to the contact surface 110 illustrated in FIG. 1, Neither the first non-radial surface 228 nor the second non-radial surface 230 coincides with a radius of the cam 200. The angle 226 between the first non-radial surface 228 and the second non-radial surface 230 can be less than 180 degrees. The angle 226 being less than 180 degrees ensures that the first non-radial surface 228 and the second non-radial surface 230 do not coincide with a radius of the cam 200. The first non-radial surface 228 and the second non-radial surface 230 can be analogized to angled projections of the first non-radial portion 220 and the second non-radial portion 222, respectively. Thus, the angle 226 can be the angle between the first non-radial portion 220 and the second non-radial portion 222. The angle 226 being less than 180 degrees ensures that the first non-radial portion 220 and the second non-radial portion 222 do not coincide with a radius of the cam.

FIG. 3 illustrates an example of a cam with non-radial abrasion edges consistent with the disclosure. As illustrated in FIG. 3, the non-radial abrasion edge 334 can be a curved non-radial abrasion edge. In some examples, the curved non-radial abrasion edge 334 can have a constant radius. As shown in FIG. 3, some examples can have a curved contact surface 336. The curved contact surface 336 can connect the first annular surface 302 to the second annular surface 304. In some examples, the curved contact surface 336 can have a constant radius. The curved contact surface 336 can be analogized to an angled projection of the curved non-radial abrasion edge 334 from the first annular surface 302 to the second annular surface 304. The angle between the curved contact surface 336 and the second annular surface 304 can be adjusted to adjust the area of the curved contact surface 336. Increasing the angle between the curved contact surface 336 and the second annular surface 304 can increase the area of the curved contact surface 336 whereas decreasing the angle can decrease the area of the curved contact surface 336.

As shown in FIG. 3, some examples can include multiple instances of the curved non-radial abrasion edge 334 and the curved contact surface 336. A first curved contact surface and a second curved contact surface can be oppositely oriented. In some examples, the concave surface of the first curved contact surface can face the concave surface of the second curved contact surface, Although not illustrated in FIG. 3, the cam 332 can be a double sided cam. The cam 332 can include a third annular surface opposite to the first annular surface 302 and a fourth annular surface opposite to the second annular surface 304. The third annular surface and the fourth annular surface can be separated from the first annular surface 302 and the second annular surface 304, respectively, by the thickness of the cam 332.

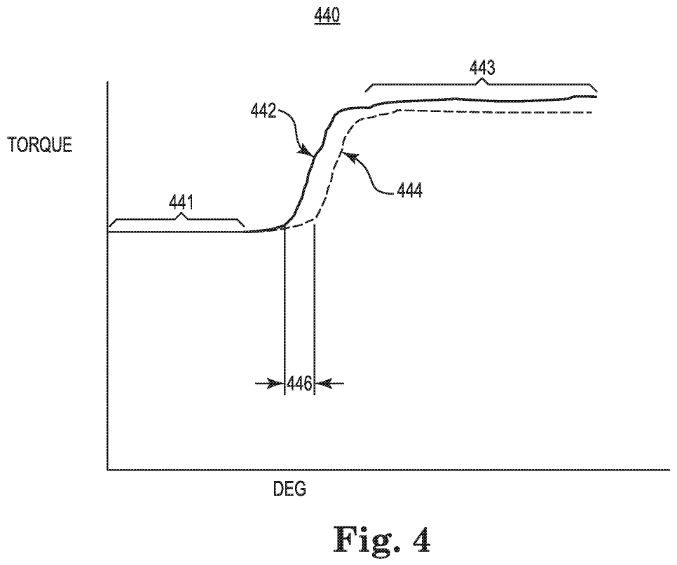

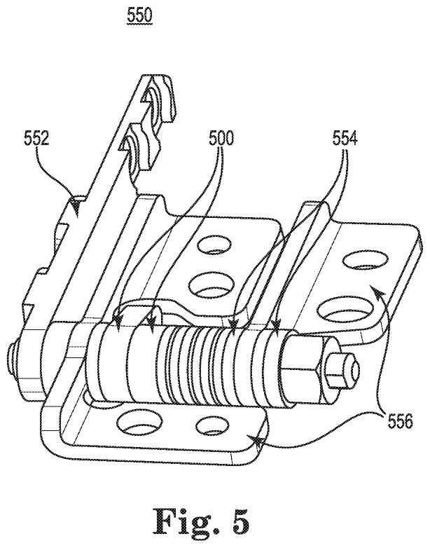

FIG. 4 illustrates a graph of a torque profile of an example of cams with non-radial abrasion edges consistent with the disclosure. The horizontal axis of the graph 440 shows the amount of rotation, in degrees, of a cam with a non-radial abrasion edge, such as the cam 100 illustrated in FIG. 1, or a hinge including a cam with a non-radial abrasion edge, such as the hinge 550 illustrated in FIG. 5. The vertical axis of the graph 440 shows the amount of torque applied to a cam or a hinge including a cam with a non-radial abrasion edge. The graph 440 shows a first torque profile 442 and a second torque profile 444. The S-shape of the first torque profile 442 and the second torque profile 444 corresponds to applying torque to the cam or the hinge to rotate the cam or the hinge from a first orientation to a second orientation and vice versa. For example, the first region 441 of the first torque profile 442 and the second torque profile 444 corresponds to a first torque position whereas the second region 443 of the first torque profile 442 and the second torque profile 444 corresponds to a second torque position. In some examples, the first torque position can correspond to a first orientation of a hinge including a cam and the second torque position can correspond to a second orientation of the hinge. For example, the first orientation can be a closed position of a hinge including a cam included in a kickstand or between a display and a base of electronic device. In contrast, the second orientation can be an open position of a hinge including a cam included in a kickstand or between a display and a base of electronic device.

The first torque profile 442 can correspond to an initial torque profile of a cam with a non-radial abrasion edge or a hinge including a cam with a non-radial abrasion edge. The increased length of non-radial abrasion edges relative to radial abrasion edges of some approaches enables cams with non-radial abrasion edges can maintain the first torque profile 442. Some examples of cams with non-radial abrasion edges can exceed 25,000 cycles and still maintain the first torque profile 442 such that an angle shift associated with the first torque profile 442 is substantially zero after 25,000 or fewer cycles. In contrast, radial abrasion edges of some other approaches may deteriorate and become damaged after 25,000 cycles or less and therefore experience greater degrees and/or earlier onset of an angle shift 446. Because of the angle shift 446, cams with radial abrasion edges may have the second torque profile 444 after 25,000 cycles. The angle shift 446 corresponds to an increase in the amount of rotation of a hinge as described above.

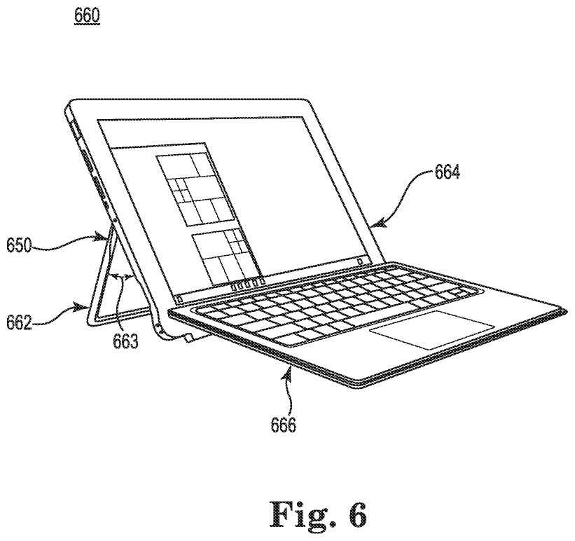

FIG. 5 illustrates an example of a hinge including an example of cams with non-radial abrasion edges consistent with the disclosure. As shown in FIG. 5, the hinge 550 can include a first bracket 552, cams 500, a torque engine 554, and a second bracket 556. In some examples, the first bracket 552 can be coupled to a kickstand (such as the kickstand 662 illustrated in FIG. 6) or a display of an electronic device (such as the base 666 illustrated in FIG. 6). The first bracket 552 can be coupled to the cams 500. Each of the cams 500 can be analogous to the cam 100 illustrated in FIG. 1 and/or the cam 332 illustrated in FIG. 3.

The cams 500 can be coupled to the torque engine 554. The torque engine 554 can have an initial (designed) torque profile, such as the first torque profile 442 illustrated in FIG. 4, including a first torque position and a second torque position. The first torque position and the second torque position can correspond to a first orientation and a second orientation of the hinge 550, respectively. The second bracket 556 can be coupled to the torque engine 554. In some examples, the second bracket 556 can be coupled to a display of an electronic device (not shown) or a base of an electronic device (not shown).

FIG. 6 illustrates an example electronic device including of an example of a hinge including an example of cams with non-radial abrasion edges consistent with the disclosure. As shown in FIG. 6, the electronic device 660 can include a hinge 650. The hinge 650 can be analogous to the hinge 550 illustrated in FIG. 5.

The hinge 650 can be coupled to a kickstand 662 of the electronic device 660 and a display 664 of the electronic device 660. The kickstand 662 can be used to support the display 664. The angle 663 indicates the amount of rotation of the hinge 650 from a first orientation (e.g., a closed position against the display 664) to a second orientation (e.g., an open position illustrated in FIG. 6). Damage to abrasion edges can cause an angle shift in the angle 663 such that the angle 663 increases over time. Desirably, cams with non-radial abrasion edges can reduce, or even eliminate, an increase in the angle 663 over time.

Although not illustrated in FIG. 6, the hinge 650 can be coupled to the display 664 and the base 666 of the electronic device 660, In some examples, the base 666 can include a keyboard and/or a trackpad.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. For example, reference numeral 102 may refer to element “02” in FIG. 1 and an analogous element may be identified by reference numeral 202 in FIG. 2. Elements shown in the various figures herein can be added, exchanged, and/or eliminated so as to provide a number of additional examples of the disclosure. In addition, the proportion and the relative scale of the elements provided in the figures are intended to illustrate the examples of the disclosure, and should not be taken in a limiting sense.

What is claimed:

1. A cam, comprising:
a first annular surface having an outer radius and an inner radius;
a second annular surface having the outer radius and the inner radius;
a contact surface connecting the first annular surface to the second annular surface; and
a non-radial abrasion edge with respect to the outer radius and the inner radius, wherein the non-radial abrasion edge is at a distal end of the contact surface.

2. The cam of claim 1, wherein the non-radial abrasion edge comprises:
a first non-radial portion of the non-radial abrasion edge; and
a second non-radial portion of the non-radial abrasion edge.

3. The cam of claim 2, wherein the first non-radial portion has a first length and a first distal end at an outer circumference of the cam, and
wherein the second non-radial portion has a second length, a first distal end at a second distal end of the first non-radial portion, and a second distal end at an inner circumference of the cam.

4. The cam of claim 2, wherein a sum of the first length and the second length is greater than a difference of the outer radius and the inner radius.

5. The cam of claim 1, wherein the non-radial abrasion edge is a curved abrasion edge.

6. The cam of claim 5, wherein the curved abrasion edge has a substantially constant radius.

7. The cam of claim 1, wherein a length of the non-radial abrasion edge is greater than a difference between the outer radius and the inner radius.

8. The cam of claim 1, further comprising:
a third annular surface having the outer radius and the inner radius, wherein the third annular surface is separated from the first annular surface by a thickness of the cam;
a fourth annular surface having the outer radius and the inner radius, wherein the fourth annular surface is separated from the second annular surface by the thickness;
a second non-radial abrasion edge with respect to the outer radius and the inner radius; and
a second contact surface connecting the third annular surface to the fourth annular surface, wherein the second non-radial abrasion edge is at a distal end of the second contact surface.

9. A cam; comprising:
a first annular surface having an outer radius and an inner radius;
a second annular surface having the outer radius and the inner radius; and
a chevron contact surface connecting the first annular surface to the second annular surface.

10. The cam of claim 9; wherein the chevron contact surface comprises:
a first non-radial surface with respect to the outer radius or the inner radius; and
a second non-radial surface with respect to the outer radius or the inner radius, wherein an angle between the first non-radial surface and the second non-radial surface is less than 180 degrees.

11. The cam of claim 9; further comprising a second chevron contact surface connecting the first annular surface to the second annular surface, and
wherein the second chevron contact surface is in an opposite orientation than the chevron contact surface.

12. The cam of claim 9, further comprising:
a third annular surface having the outer radius and the inner radius, wherein the third annular surface is separated from the first annular surface by a thickness of the cam;
a fourth annular surface having the outer radius and the inner radius, wherein the fourth annular surface is separated from the second annular surface by the thickness;
a second non-radial abrasion edge with respect to the outer radius and the inner radius; and
a second chevron contact surface connecting the third annular surface to the fourth annular surface.

13. A hinge, comprising:
a cam comprising a non-radial abrasion edge with respect to an outer radius of the cam and an inner radius of the cam;
a first bracket coupled to the cam;
a torque engine coupled to the cam; and
a second bracket coupled to the torque engine.

14. The hinge of claim 13, wherein a torque profile of the cam includes two different torque positions.

15. The hinge of claim 14, wherein the two different torque positions include:
a first torque position corresponding to a first orientation of the hinge; and
a second torque position corresponding to a second orientation of the hinge.
